(19) United States
(12) Patent Application Publication
(10) Pub. No.: US 2005/0021511 A1
(43) Pub. Date: Jan. 27, 2005

(54) System and method for load balancing in database queries

(75) Inventor: Rony Zarom, New York, NY (US)

Correspondence Address: MARTIN MOYNIHAN;c/o ANTHONY CASTORINA, SUITE 207, 2001 JEFFERSON DAVIS HIGHWAY, ARLINGTON, VA, 22202, US

(73) Assignee: Etagon Israel Ltd.

(21) Appl. No.: 10/895,952

(22) Filed: Jul. 22, 2004

Related U.S. Application Data
(60) Provisional application No. 60/489,508, filed on Jul. 24, 2003.

(51) Int. Cl. G06F 7/00

(52) U.S. Cl. 707/3

(57) ABSTRACT

A system and method in which query load balancing process is performed in a cluster of middle-tier computing elements according to the load on at least one, but more preferably a plurality, of the computing elements of the group, this by passing pointers to queries between machines with information or processes pertinent to the query. Optionally the balancing may be carried out in two stages. The first stage performed rapidly, preferably implemented as a hardware device such as a switch for example in which a plurality of queries is distributed to a plurality of computing elements according to at least one descriptor attached to each query or a simple algorithm is used. The second stage preferably performed as above by at least one computing element of the group, but may optionally be performed by a plurality of such elements. Alternatively, the second stage may be performed by a separate computer.

This application claims the benefit of priority from U.S. provisional patent application No. 60/489,508, filed Jul. 24, 2003.

### FIELD OF THE INVENTION

The present invention is of a system and method for database query load balancing, and in particular, of such a system and method in which the load is distributed between a plurality of computing elements according to the nature of the query, with an optional initial rapid distribution process according to at least one descriptor attached to each query. Preferably, a second distribution process is performed through the operation of the computing elements themselves. The nature of the query is optionally and preferably at least partially determined according to a descriptor that is associated with the query.

### BACKGROUND OF THE INVENTION

Systems are known in the art in which a plurality of computers receives queries from one or more clients. These computers then need to perform some task in response to the query. The tasks should be evenly distributed between these computers, in order to prevent the situation from arising in which one computer has more work to perform than the others.

Load balancing is a well known mechanism in the art for adjusting the amount of work which must be performed by each of a plurality of computers in a group. For operations with a database, load balancing may also optionally be referred to as “query distribution”. In order to evenly distribute the load between these different computers, a load balancer is often employed. The load balancer is a computer (or other similar device) which distributes the load by determining which of the group computers should receive a particular data transmission. The goal of the load balancer is to ensure that the most efficient distribution is maintained, in order to prevent a situation in which one computer or CPU is idle while another computer or CPU is suffering from degraded performance because of an excessive load.

One difficulty with maintaining an even balance between these different servers is that once a session has begun between a client and a particular computer of the group, the session is generally continued with that computer. The load balancer therefore maintains a session table, or a list of the sessions in which each computer is currently engaged, in order for these sessions to be maintained with that particular computer, even if that computer currently has a higher load than other computers.

Many different rules and algorithms have been developed in order to facilitate the even distribution of the load by the load balancer. Examples of these rules and algorithms include determining load according to computer responsiveness and/or total workload; and the use of a “round robin” distribution system, such that each new session is systematically assigned to a computer, for example according to a predetermined order.

Unfortunately, as currently implemented, all of these rules and algorithms have a number of drawbacks. The “round robin” distribution system may not accurately reflect the actual load on each computer. Other algorithms which attempt to compensate for different actual work loads have other drawbacks. For example, for these algorithms, the load balancer must maintain a session table. Therefore, the load balancer must receive feedback from each computer in order to determine the current load on that computer. Such feedback communication may also further slow the process of distributing the load across a number of computers by requiring additional bandwidth for communication, and additional CPU cycles for both communication and implementing the actual load balancing process.

The issue of load balancing is especially acute in the field of middle-tier database queries, where database hereinafter includes any information set organized for flexible searching and utilization, and the “middle-tier” server hereinafter includes any computer in a three-tier architecture which retrieves information from the database, performs some type of business logic with this information and then delivers it either back to the database (third tier) or to a user (first-tier).

There is a huge and ongoing loss of resources in middle-tier server clusters as a result of the fact that many servers often require the same subsets of information from the database as part of their activities. Because load balancing is regularly done on an external computer (“load balancer”) according to the background art, two or more nodes (servers) requiring the same information are unaware of each other and must both request this identical information from the server, causing the server to then send it repeatedly across the network, creating needless duplication and resource use.

U.S. Pat. No. 5,778,224 teaches a system for load distribution which is characterized by having a plurality of different possible distribution models, for greater flexibility in determining the process according to which the jobs are distributed. However, the invention focuses on generic computation, and does not address the specific requirements for processing of queries. The configurations taught are pre-arranged and can thus do nothing dynamic to take spontaneous advantage of extant information in the group of computers which are receiving the jobs.

U.S. Pat. No. 6,105,067 teaches a system for enhancing the performance of computers in a Web environment, by providing a connection manager between a Web-based server and a data server. A Web browser connects to the Web server, which in turn seeks a connection from a pool of connections. The connection manager manages this pool. When a connection is made, the Web browser is able to retrieve data from the data server. The pool of connections enables a connection to be maintained between the Web server and the data server, with different Web browsers sending in requests.

Therefore, this patent is concerned with the physical nature of the connections, rather than the distribution of requests according to the content of the requests. Also, the described system does nothing to reduce resource drain by passing of queries.

U.S. Pat. No. 6,374,297 describes a system for load balancing among a plurality of Web servers, in which the load balancing system features two components. A first static component assigns copies of Web pages to servers. The second dynamic component determines which Web browser receives the Web page from which server. A probabilistic approach is used to assign Web browsers to servers for receiving the Web page. This patent therefore only considers statistical probability for distributing requests. In that sense, this system treats requests for Web pages as generic “jobs” which differ radically from database requests in that there is no middle tier, and no scope for reduction of network traffic as each client needs to see all the information it requests.

### SUMMARY OF THE INVENTION

The background art does not teach or suggest a system or method for efficient query load distribution according to at least one descriptor attached to each query and without implementing the load balancer as a computer. The background art also does not teach or suggest such a system or method in which the computers of the group for which load balancing is being performed are able to assist in the management process for load distribution, and to reduce the number of operations needed by sharing queries and query results. Furthermore, the background art does not teach or suggest a system or method for load distribution according to information attached to each query or unit of the workload.

The present invention overcomes these drawbacks of the prior art by providing a system and method in which the load balancing process is performed according to the nature of the query, and optionally also according to one or more characteristics of the computing elements. The nature of the query is optionally and preferably at least partially determined according to a descriptor that is associated with the query. The descriptor is more preferably attached to the query. The descriptor is optionally and most preferably related to the query itself. Examples of descriptors include but are not limited to, the time of day, the priority of the user (client) transmitting the query, the priority of the application to which the query is related,. and the priority of the query itself, for example as set by the user. Information concerning the identity of the user/client transmitting the query may optionally be determined according to the IP address of the client.

The process of query distribution is optionally and preferably performed in two stages. The first stage is preferably performed rapidly, and preferably is performed by a hardware device. The hardware device preferably performs the process of initial distribution of the load through the operation of the algorithm in hardware, which may optionally be implemented in one or more chips and/or other hardware component, a programmable ASIC, instructions burnt into a memory device such as an EEPROM for example, or any other suitable type of hardware. The hardware device is more preferably a switch, although it may optionally feature a router.

This optional first stage may optionally and preferably use at least one descriptor attached to each query which preferably corresponds to at least one rule in a rule table, which is preferably used to determine which computing element should receive and execute the query or may optionally use a relatively simple algorithm such as the previously described “round robin” algorithm, but in any case produces extremely rapid, possibly hardware driven initial distribution of the load to the computing elements of the group.

The most preferable second stage then involves the balancing redistribution of at least a portion of the load, according to one or more of the characteristics, load and resources for at least one, but more preferably a plurality, of the computing elements of the group as delineated above.

According to preferred embodiments of the present invention, one or more redistributive and/or distributive processes may be performed for the second stage of load balancing. For example, optionally, one of the plurality of computing elements initially receives the query, and may then determine whether to execute the query or to pass the query to another computing element, preferably by comparing the descriptor to a virtual table. Optionally and preferably, the computing element which initially receives the query may be given preference as to execution thereof.

According to an alternative embodiment of the present invention, the queries themselves are not passed between computing elements, but rather a pointer to each query is preferably passed. The pointer, more preferably with the at least one descriptor, would be sent to the plurality of computing elements which could then optionally and preferably accept and process the query. The pointer preferably indicates a location of the actual query, which may for example optionally be stored on one of the computing elements. The descriptor is preferably sent with the pointer in order to be able to assign the actual query to a computing element. This embodiment is advantageous in that it reduces the initial message size, since the pointer preferably is much smaller than the query; once a computing element has accepted the query according to the pointer (and preferably also element.

According to another embodiment of the present invention at least one of the computing elements stores a virtual queue of query requests and of query results still stored in the memory of other computing elements. Query distribution and sharing can then be achieved by referencing the virtual query queue. The table is more preferably stored and simultaneously updated on all computing elements, allowing elements to transfer pointers to queries to other computers in accordance with information already extant in the memory of each computing element. The virtual query queue is optionally and preferably used with other aspects of the present invention for more efficient distribution of queries.

According to a further embodiment of the current invention, at least one computing element may optionally act as the manager of the cluster of computing elements, in which a cluster is optionally a plurality of communicating computing elements. The manager would preferably receive the queries, and would then distribute them preferably in accordance with the delineated optional criteria described in greater detail below, additionally or alternatively, according to at least one descriptor attached to each query, more preferably by comparing the at least one descriptor to a table of rules.

More preferably a plurality of computing elements may act as the manager; indeed, optionally and most preferably, each computing element is capable of acting independently as a query manager, and to distribute one or more queries to other computing elements. For example, when a computing element develops an increased load compared to other computing element(s), and/or is overloaded (optionally according to a threshold of activity), the computing element is preferably able to distribute one or more queries to other computing element(s). In this sense, most preferably each computing element is both able to handle queries independently, including managing such queries, and also operates in conjunction with other computing elements for receiving a query or queries for execution from these other computing elements.

According to another preferred embodiment of the present invention, the computing elements in question are middle tier servers in a server farm which hereinafter includes any managed collection of computing elements in a single location, optionally and preferably providing computational services for any number of disparate owners. In this embodiment, the number of computing elements may be exceptionally large, and each element may be focused on any one of a plurality of tasks. Thus in this embodiment it is most preferable for the computing element to monitor its own activities; when the element has less than a predetermined level of activity, the element preferably independently initiates a request to the manager for an additional query. More preferably, the element includes one or more matching criteria to the computing element's resident data, in order to increase the efficiency of processing the query when received by the manager.

Optionally and preferably, any combination of the above embodiments may be used in the present invention.

The present invention has a number of advantages over systems and methods taught in the background art. By way of example only, the present invention is more advantageous than the system for load distribution that is taught in U.S. Pat. No. 5,778,224. The latter does not teach content-based distribution, nor does it consider the use of a highly simplistic first layer of load distribution, for example through a router, with a second layer performed according to a “smart” distribution process, such as a content based distribution process for example. The configurations taught are pre-arranged and can thus do nothing dynamic to take spontaneous advantage of extant information in the group of computers which are receiving the jobs. By contrast, the present invention embodies flexibility and also may optionally feature two or more layers of load distribution.

U.S. Pat. No. 6,374,297 describes a system for load balancing among a plurality of Web servers, in which the load balancing system features two components. However, the taught load balancing system does not feature a two layer approach to distributing requests, in which the first layer is performed by a simplistic hardware device, such as a router for example. This patent also does not consider the content of a request for a Web page, but only statistical probability for distributing requests. Again, according to preferred embodiments of the present invention, these drawbacks are overcome.

U.S. Pat. No. 5,241,677 teaches a system which features two processes for load balancing, as part of execution of a software program by a plurality of processors. The first process involves distribution to the plurality of processors, without regard to the load received by other processors. This distribution is performed by having the processors themselves select part of the work load to perform. In the next process, processors share information about their respective loads. However, the invention does not teach a first distribution process performed by a simple central hardware device, such as a router for example. Instead, the processors themselves must perform the initial distribution, which increases the load on individual processors.

The term “computing element” includes but is not limited to a computer, a server computer, a CPU, a microprocessor, a data processor, a plurality of any of these or a combination thereof.

### BRIEF DESCRIPTION OF THE DRAWINGS

The invention is herein described, by way of example only, with reference to the accompanying drawings, wherein:

FIG. 1 is a schematic block diagram showing a system according to the present invention; and

FIG. 2 is a flowchart of an exemplary method according to the present invention.

### DESCRIPTION OF THE PREFERRED EMBODIMENTS

The present invention is of a system and method in which the load balancing process is performed according to the nature of the query, and optionally also according to one or more characteristics of the computing elements. The nature of the query is optionally and preferably at least partially determined according to a descriptor that is associated with the query. The descriptor is more preferably attached to the query. The descriptor is optionally and most preferably related to the query itself. Examples of descriptors include but are not limited to, the time of day, the priority of the user (client) transmitting the query, the priority of the application to which the query is related, and the priority of the query itself, for example as set by the user. Information concerning the identity of the user/client transmitting the query may optionally be determined according to the IP address of the client.

The process of query distribution is optionally and preferably performed in two stages. The first stage is preferably performed rapidly, preferably implemented as a hardware device such as an intelligent switch for example. This optional first stage may optionally and preferably use at least one descriptor attached to each query which preferably corresponds to at least one rule in a rule table, which is preferably used to determine which coupling element should receive and execute the query or may optionally use a relatively simple algorithm such as the previously described “round robin” algorithm, but in any case produces extremely rapid, possibly hardware driven initial distribution of the load to the computing elements of the group.

Most preferably, the second stage involves the balancing redistribution of at least a portion of the load, according to the characteristics, load and resources known for at least one, but more preferably a plurality, of the computing elements of the group as delineated above. For example, the process preferably includes one or more of the following: determining the current load on at least one computing element, and analyzing the characteristics and/or resources available to that computing element, in order to consider whether a load balancing redistribution is appropriate.

According to an optional but preferred implementation of the present invention, the computing elements of the group receive the load in the form of a request from a client. The request may optionally be to initiate a session, in which case the load comprises a plurality of sessions with one or more clients. The request may alteratively be for a discrete unit of data, such as a query for a database for example, in which case the load comprises a plurality of queries for units of data to be returned.

For this implementation, optionally and more preferably the computing elements are in communication with and are able to execute the query with a database, such that the system of the present invention preferably includes such a database. The queries are therefore requests to search through the database.

The descriptor optionally and preferably corresponds to at least one rule in a rule table, which is preferably used to determine which computing element should receive and execute the query. The rule table is more preferably loaded into a rapidly accessible memory by each computing element, such as a RAM memory, most preferably from a central location.

The descriptor is optionally and more preferably related to the query itself. Examples of descriptors include but are not limited to, the time of day, the priority of the user (client) transmitting the query, the priority of the application to which the query is related, and the priority of the query itself, for example as set by the user. Information concerning the identity of the user/client transmitting the query may optionally be determined according to the IP address of the client.

The second stage may optionally be handled or otherwise controlled by a “manager”. Optionally, a single computing element, or a plurality of designated computing elements, may act as the manager. More preferably a plurality of computing elements collectively act as the manager; indeed, optionally and most preferably, each computing element is capable of acting independently as a query manager, and of distributing one or more queries to other computing elements. For example, when a computing element develops an increased load compared to other computing element(s), and/or is overloaded (optionally according to a threshold of activity), the overloaded computing element itself is preferably able to distribute one or more queries to other computing element(s). In this sense, most preferably each computing element is both able to handle queries independently, including managing such queries, and also operates in conjunction with other computing elements for receiving a query or queries for execution from these other computing elements.

For either embodiment (e.g. for one or more designated computing elements as the manager or for all computing elements that are capable of acting as a manager), the “manager” preferably has a list of queries being handled by the computing elements of the group, and as previously described, causes or at least enables a requesting computing element to receive at least one additional query from a transferring computing element. Optionally and preferably, the computing element which initially receives the query (for example from the optional but preferred first stage of load distribution, as described above) may be given preference as to execution thereof.

One or more computing elements could then optionally and preferably send a message to another computing element(s) acting as the manager, requesting the query because of information already available in memory in that requesting computing element. More preferably, this embodiment may be optionally combined with the previously described embodiment if more than one computing element requests the query, by enabling the manager to decide which of the plurality of requesting computing elements should receive the query, or most preferably allowing them to share subsets of the query in accordance with the information that they already have available.

According to an additional embodiment of the present invention, each computing element in the group sends a request to computing element(s) acting as the manager for another part of the load when the requesting computing element has no work to perform and/or for which the level of work has dropped below a minimum, which is most preferably predetermined. This method is most preferable in the event that the plurality of computation elements are arranged in a server farm, and may be large in number, and focused on any one of a plurality of tasks. In this embodiment, the computing element optionally monitors itself and when it has fallen below a pre-determined level of activity may initiate a request to the manager for an additional query—preferably and optionally a query which matches criteria of the computing element and its resident data.

Each computing element acting as a manager, which could optionally include all computing elements as previously described, preferably has a list of the portion of the load being handled by each computing element in the group, and is preferably able to transfer an additional part of the load from at least one computing element in the group to the computing element requesting another part of the load. Optionally, the manager sends a request to the computing element which should transfer the additional part of the load, for that element to transfer the additional part of the load to the requesting computing element. Alternatively, the manager sends identifying information concerning the transferring computing element to the requesting computing element, and the latter computing element sends the request directly to the transferring computing element. Also alternatively, the manager may remove the additional part of the load directly from the transferring computing element, and then transfer that part directly to the requesting computing element.

According to another, alternative or additional embodiment according to the present invention, the computing elements update the manager periodically on their load status, according to some type of defined time period and/or work cycle (for example, a cycle could optionally be defined as including a predefined number of queries), regardless of the current work load. Again, if the manager is a plurality of computing elements, then each computing element preferably updates each manager computing element periodically; if the manager comprises all computing elements, then all of the computing elements preferably update each other periodically. The manager then preferably assigns the queries to the computing elements according to some rules. According to this embodiment, the computing element does not need to wait until the work load has reached a certain level in order to request a query. This embodiment and the previous embodiment may also optionally be combined.

For any of the embodiments above, preferably communication between the different computing elements is performed according to a messaging protocol over some standard network protocol, including but not limited to, TCP/IP or NetBios.

It should be understood that for each of the embodiments above which include at least one computing element as a manager, the operation of a plurality of computing elements as a collective manager preferably does not require the different managing computing elements to be in contact and/or to coordinate with each other, and/or to perform management tasks in conjunction. Instead, more preferably each computing element that acts as a manager does so independently of any other computing element(s) that may also be acting as a manager.

The principles and operation of a system according to the present invention may be better understood with reference to the drawings and the accompanying description. It should be noted that although the following description centers around receiving and distributing “queries”, in fact any unit of workload may optionally be used to replace the term “query”. The present invention is considered to encompass all such units of workload.

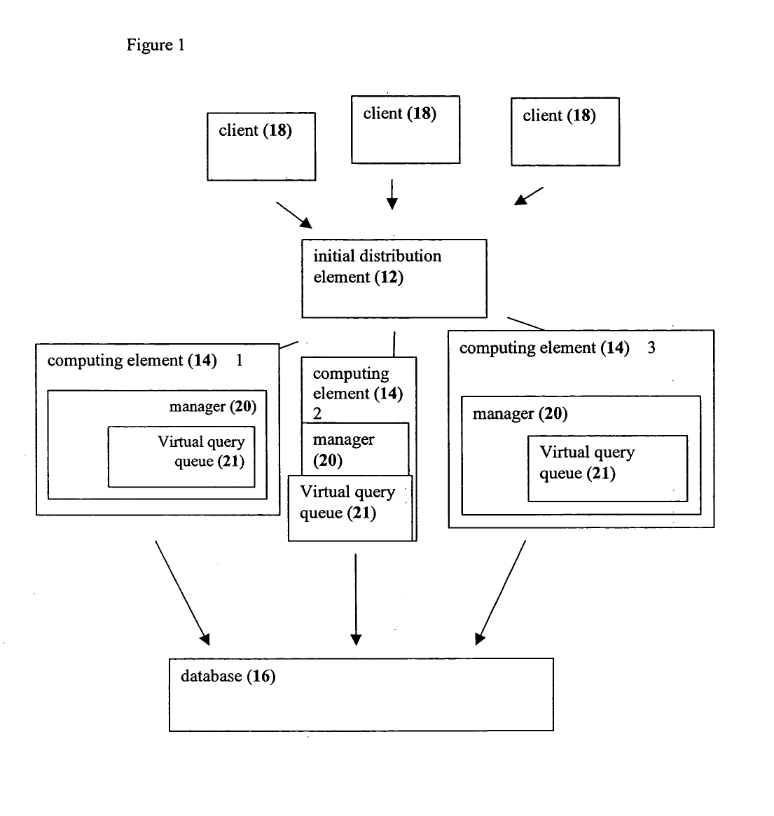

Referring now to the drawings, FIG. 1 shows an exemplary implementation of a system 10 according to the present invention for load balancing. As shown, system 10 features an initial distribution element 12 for distributing the query load to a plurality of computing elements 14 in a group for the initial processing and distribution stage. Initial distribution element 12 is preferably implemented as a hardware device, and is more preferably an intelligent switch. The hardware device may optionally be implemented in one or more chips and/or other hardware component, a programmable ASIC, instructions burnt into a memory device such as an EEPROM for example, or any other suitable type of hardware.

Initial distribution element 12 preferably performs the initial stage of distribution by first assigning different parts of the load, for example a plurality of queries, to each computing element 14. Each query optionally has at least one attached descriptor, according to which the query is distributed to one of the plurality of computing elements 14.

Computing element 14 is optionally and preferably one or more of a computer, a server computer, a CPU, a microprocessor, a data processor, a plurality of any of these or a combination thereof. Three such computing elements 14 are shown, marked as “1”, “2” and “3” respectively, for the purposes of illustration only and without any intention of being limiting. Initial distribution element 12 may optionally and preferably initially assign the plurality of queries (or other type of load) according to at least one descriptor attached to each query which preferably corresponds to at least one rule in a rule table, which is preferably used to determine which computing element should receive and execute the query or may use an algorithm which is a “round robin” algorithm for example, or alternatively any type of rapidly executable algorithm. Initial distribution element 12 then transfers the different parts of the load, such as the queries for example, to computing elements 14.

Computing elements 14 perform one or more tasks and/or computations and/or actions which are required for handling the load. For example, if the load comprises a plurality of queries, according to a preferred embodiment of the present invention, and computing elements 14 are in contact with a database 16, then each computing element 14 preferably searches through, or otherwise interacts with, database 16 in order to retrieve data to fulfill the query. In this preferred embodiment, the queries are sent by a plurality of clients 18, such that upon retrieving the data, computing element 14 returns the data to the respective client 18.

According to the present invention, once initial distribution element 12 has performed the initial distribution of the load (such as queries for example), then a manager 20 of computing elements 14 performs a redistribution process for at least part of the load, such as at least one query for example, from at least one computing element 14. Manager 20 is shown as being present at every computing element 14, such that the designation “manager” may optionally refer to a functional description rather than a separate physical component of system 10. However, it is understood that manager 20 may optionally only be present at one computing element 14, or optionally and more preferably may be present at a plurality of computing elements 14. Initial distribution element 12 is preferably not involved in this second stage of the load balancing process.

Regardless of the number of manager(s) 20, and/or the presence of manager 20 at every computing element 14, the operation of manager 20 is preferably similar for all of these configurations. Manager 20 preferably compares the descriptor to a table of rules and or active queries, which may optionally be stored locally, for example in a hard disk or other local access storage device (not shown). More preferably the table of rules is loaded into a rapidly accessible memory of manager 20, such as RAM for example (not shown). The function(s) of manager 20 may optionally and preferably be replicated in all computing elements 14.

If a computing element 14 has no work to perform, such as no queries to execute and/or search for through database 16 for example, or at the very least has a work level which has fallen below a minimum, then computing element 14 preferably sends a request to manager 20 for additional work.

According to another, alternative or additional embodiment according to the present invention, computing element 14 preferably updates manager 20 periodically with regard to the load status, according to some type of defined time period and/or work cycle (for example, a cycle could optionally be defined as including a predefined number of queries), regardless of the current work load. Manager 20 then preferably assigns the queries to each computing element 14 according to some rules. According to this embodiment, computing element 14 does not need to wait until the work load has reached a certain level in order to request a query. This embodiment and the previous embodiment may also optionally be combined.

In the preferred example illustrated herein, manager 20 maintains a virtual query queue 21 of all queries currently being handled by computing elements 14. Virtual query queue 21 is refreshed and/or updated according to a predetermined frequency, or alternatively as each query is finished by a computing element 14. Once the requesting computing element 14, for example computing element 14 “1”, sends the request for at least one additional query to manager 20, manager 20 preferably examines Virtual query queue 21. Manager 20 optionally and more preferably determines which computing element 14 currently has the highest load, for example the highest number of queries to perform. The “highest load” may also optionally be relative the amount of work needed for specific machine to complete the query with respect to information is already contains and work already done for to some additional characteristic of each computing element 14, such as the relative amount of computational power for example. Alternatively, manager 20 may optionally recalculate this information periodically (as opposed to “on the fly” or upon receiving the request).

Preferably, load monitoring is performed periodically by manager 20 and/or another device (not shown); frequency may optionally be determined by the user and/or the application. The query process, or virtual query queue 21, is preferably updated upon each event. Example of query events include but are not limited to, receiving a new query, in which case the new query is added to Virtual query queue 21 and processing is started; assigning a query to computing element 14; and deleting a query, upon completing the execution of the query.

In any case, once manager 20 has determined which computing element 14 has the highest relative load, such as computing element 14 “2” for example, manager 20 causes (directly or indirectly) a query (part of the load) to be transferred or is preferably able to transfer an additional part of the load from computing element 14 “2” to computing element 14 “1”.

Optionally, manager 20 sends a request to computing element 14 “2” for computing element 14 “2” to transfer the additional part of the load, such as a query, to computing element 14 “1” (the requesting computing element). Alternatively, manager 20 sends identifying information concerning computing element 14 “2” (the transferring computing element) to computing element 14 “1” (the requesting computing element). Computing element 14 “1” then sends the request directly to computing element 14 “2”. Also alternatively, manager 20 may remove the additional part of the load directly from computing element 14 “2” (the transferring computing element), and then transfer that part directly to computing element 14 “1”. For any of these actions, manager 20 preferably notes the change on the virtual query queue or other type of load.

Also alternatively, the system may optionally lack such a central managing element, such as manager 20, and may instead distribute queries to all computing elements 14. The queries may then optionally be redistributed, although preferably a computing element 14 which initially receives a query is given preference to execute the query, if not all computing elements 14 receive all queries.

If a plurality of managers 20 is present, including the embodiment in which every computing element 14 operates a manager 20, then preferably each such manager 20 operates independently. Optionally, a plurality of managers 20 may communicate with each other in order to facilitate management operations, for example by exchanging information about the list of queries or other type of load.

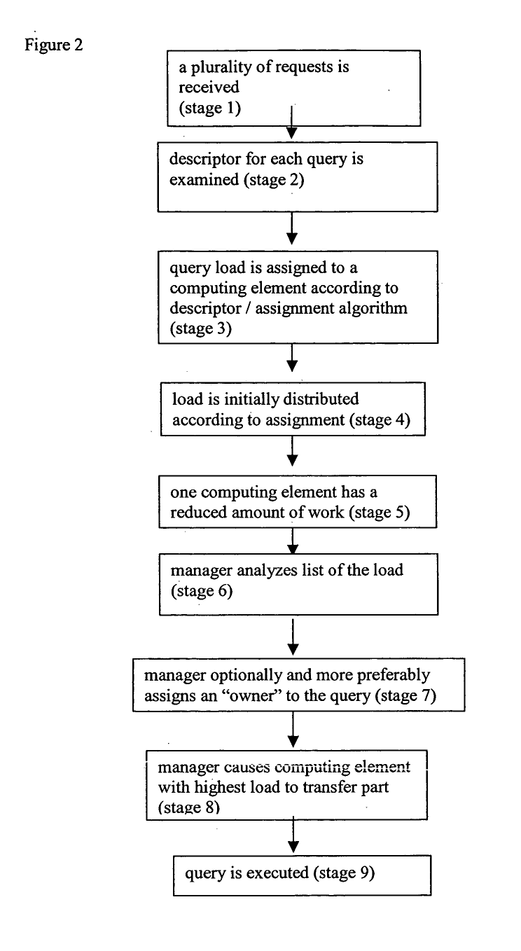

FIG. 2 shows a flowchart of an exemplary method according to the present invention. As shown, in stage 1, a plurality of requests is received, for example as a plurality of queries. Alternatively, the load could optionally be received in any other type of format.

In stage 2, a descriptor for each query is examined, and preferably compared to a table of rules. This comparison may optionally be performed most preferably by a hardware component or optionally by all computing elements, a plurality of computing elements, or a manager. As previously described, the manager may optionally be one of the computing elements. Optionally and more preferably, the role of “manager” is shared between a plurality of the computing elements, such that the plurality of computing elements receives one or more queries, and then determines whether to keep the query or to send it to another computing element. Most preferably, each computing element has a manager which performs independently to distribute the load. Available queries (for being handled by a computing element) are optionally and preferably stored in a virtual query queue, which is optionally and more preferably present at each manager.

In stage 3, the load is assigned according to the descriptor, and preferably according to the comparison between the descriptor and the table of rules. Again, the manager may optionally assign the query, or alternatively or additionally one or more computing elements may transmit a request for the query. Also alternatively, all computing elements may optionally receive the queries, such that the queries are preferably redistributed according to the descriptor and the virtual query queue. Optionally this step maybe carried out according to a rapidly performed assignment algorithm. The algorithm may optionally be simple, such as a round robin algorithm for example, but in any case is preferably performed by a hardware device such as a switch for example.

Next, in stage 4, the load is initially distributed to a plurality of computing elements according to the assignment. For example, if the load is a plurality of queries, then the queries are distributed to the plurality of computing elements.

In stage 5, one of the computing elements finishes the entirety of the portion of the load assigned to that computing element, or at least has a level of work to be performed (portion of the load) which falls below a minimum level. That computing element sends a request for more work to a manager, which as previously stated is optionally another one of the computing elements, but may alternatively be another computer or some other component of the system. Also optionally, a plurality of the computing elements may fulfill the role of the manager in sequence.

In stage 6, the manager analyzes a list of the portion of the load being handled by each computing element, which may be for example a list of queries (virtual query queue). The manager then determines which computing element has the highest load, which may be determined relative to the characteristics of each computing element, such as computational power or memory load for example, or any other parameter related to available processing power. The highest load may also optionally at least partially be determined according to the number of queries, but more preferably is at least partially determined according to the workload represented by those queries relative to extant data already in the computing element.

According to additional preferred embodiments of the present invention, one or more parameters may optionally be set for at least partially determining whether a query is to be transferred. For example, the manager may have a parameter set in which the query preferably remains at the computing element which currently holds that query, or there may be a particularly strong bias towards moving a query to computing element which holds a superset of necessary data which can be trimmed without any network or device calls for example. As another example, the query is optionally and preferably first transferred to a computing element that is best suited to perform that specific query, because of available processing power for example. This latter parameter is preferably considered separately from the actual query load being handled by that computing element. As another example, optionally computing elements that have previously handled certain queries are preferentially assigned to handle similar queries as the method of carrying out the query (parsing) may still be available on that element. As yet another example, optionally and preferably, queries which require special data are preferably sent to the computing element(s) which already have (or at least have access to) this data.

In stage 7, the manager optionally and more preferably assigns an “owner” to the query, in which the owner is one of the computing elements. That computing element now becomes responsible for the query.

In stage 8, the manager preferably causes the computing element which has the highest load to transfer at least a part of that load, such as at least one query for example, to the requesting computing element. The manager may optionally perform the transfer directly, but preferably sends a request to the computing element with the highest load to transfer a part of that load to the requesting computing element. In stage 9, the query is performed and the result(s) are returned to the clients. Optionally and more preferably, the manager updates the list of the portion of the load being handled by each computing element (virtual query queue) once the query is served.

It will be appreciated that the above descriptions are intended only to serve as examples, and that many other embodiments are possible within the spirit and the scope of the present invention.

1. A method for distributing at least one query to a plurality of computing elements, the query featuring at least one descriptor, the method comprising:
analyzing the at least one descriptor of the query; and
sending the query to a computing element according to the at least one descriptor.

2. The method of claim 1, wherein analyzing the at least one descriptor further comprises:
providing a plurality of rules; and
comparing the at least one descriptor to said plurality of rules.

3. The method of claim 2, wherein said plurality of rules is provided to a manager, and said manager receives the query and compares the at least one descriptor to said plurality of rules.

4. The method of claim 3, wherein said manager distributes the query to said computing element according to analysis of the at least one descriptor.

5. The method of claim 4, wherein said manager is at least one of the plurality of computing elements.

6. The method of claim 5, wherein said manager is a plurality of computing elements.

7. The method of claim 6, wherein preference is given to retaining the query at a computing element initially receiving the query as manager.

8. The method of claim 6, further comprising:
detecting that a number of queries at a computing element is below a predetermined level;
identifying a computing element having a highest number of queries; and
redistributing at least one query from said computing element having said highest number of queries to said computing element having said number of queries below said predetermined level.

9. The method of claim 1, comprising:
initially distributing the queries according to a first rapid algorithm, wherein said initial distribution is performed before said analyzing.

10. A system for distributing a load, comprising:
(a) a plurality of computing elements for receiving at least a portion of the load;
(b) an initial distribution element for performing an initial distribution of said at least a portion of the load, wherein said initial distribution element comprises a dedicated hardware device; and
(c) a manager for managing a redistribution of at least a part of said at least a portion of the load from at least one of said plurality of computing elements to at least another of said plurality of said computing elements.

11. The system of claim 10, wherein said dedicated hardware device is selected from the group consisting of a switch and a router.

12. The system of claim 10, wherein said manager is one of said plurality of computing elements.

13. The system of claim 10, wherein said manager is any of said plurality of computing elements, such that a plurality of said computing elements manage said redistribution sequentially.

14. The system of claim 10, wherein said initial distribution element is a hardware device, such that an assignment of said at least a portion of the load for said initial distribution is performed by hardware.

15. The system of claim 14, wherein said manager is a separate computing element.

16. The system of claim 10, further comprising a database, wherein the load features a plurality of queries for the database, and said initial distribution element initially distributes said plurality of queries to said computing elements and said manager redistributes queries between said computing elements.

17. The system of claim 16, wherein said manager directly removes at least one query from a computing element having a highest load and redistributes said at least one query to a second computing element.

18. The system of claim 17, wherein said second computing element sends a request to said manager before said manager directly removes said at least one query.

19. The system of claim 18, wherein said second computing element sends said request when a number of queries at said second computing element falls below a minimum number.

20. The system of claim 10, wherein said redistribution of at least a part of said at least a portion of the load is performed by analyzing said queries in the load according to at least one descriptor and performing said redistribution according to said analysis.

21. The system of claim 14, wherein each computing element operates a manager.

22. The system of claim 21, wherein each manager operates independently.

23. The system of claim 21, wherein each manager features a virtual query queue for containing a list of available queries.

24. A system for distributing a load, the load comprising a plurality of queries, each query featuring at least one descriptor, the system comprising:
(a) an initial distribution element for performing an initial distribution of said at least a portion of the load; and
(b) a plurality of computing elements for receiving at least a portion of the load, wherein each computing element comprises a manager, said manager functioning in at least one computing element for managing a redistribution of at least a part of said at least a portion of the load from at least one of said plurality of computing elements to at least another of said plurality of said computing elements, wherein said redistribution is performed by analyzing each query according to the at least one descriptor and performing said redistribution according to said analysis.

25. The system of claim 24, further comprising a virtual query queue at each of said managers, said virtual query queue containing a list of available queries.
